(19) United States
(12) Patent Application Publication
(10) Pub. No.: US 2025/0159578 A1
(43) Pub. Date: May 15, 2025

(54) MANAGING RECONFIGURATION IDENTIFIERS

(71) Applicant: Nokia Technologies Oy, Espoo (FI)

(72) Inventors: Ahmad AWADA, Munich (DE); Srinivasan SELVAGANAPATHY, Bangalore (IN); Jedrzej STANCZAK, Wroclaw (PL)

(21) Appl. No.: 18/840,064

(22) PCT Filed: Feb. 1, 2023
(86) PCT No.: PCT/EP2023/052378

§ 371 Date: Aug. 20, 2024

(30) Foreign Application Priority Data
Feb. 23, 2022 (IN) 202241009622

(51) Int. Cl. H04W 36/36; H04W 36/00

(52) U.S. Cl. CPC H04W 36/362; H04W 36/00692

(57) ABSTRACT

This document discloses a solution for handling a conflict of identifiers in a terminal device. According to an aspect, a method comprises: receiving a first cell change message of a first cell change procedure from a first access node serving the terminal device, the first cell change message comprising an identifier of the first cell change procedure; receiving a second cell change message of a second cell change procedure from a second access node serving the terminal device, the second cell change message comprising an identifier of the second cell change procedure, wherein the identifier of the first cell change procedure is identical to the identifier of the second cell change procedure; using information on the first access node and information on the second access node to distinguish the first cell procedure and the second cell change procedure in the apparatus.

### FIELD

Various embodiments described herein relate to the field of wireless communications and, particularly, to managing handovers.

### BACKGROUND

A terminal device may have a communication link with a Master Node (MN) via a Master Cell Group (MCG) consisting of primary cell of MCG (PCell) and Secondary Cells (SCells) and another communication link with a Secondary Node (SN) via a Secondary Cell Group (SCG) consisting of primary cell of SCG (PSCell) and SCells. Changes of both PCell and PSCell are possible. The handover/change of PCell may be controlled by the MN, while the change of PSCell may be controlled by either MN or SN. For each conditional cell change of PCell or PSCell, a reconfiguration identifier may be allocated to identify a specific conditional reconfiguration that is executed by the UE once a corresponding condition is met. The conditional reconfigurations for PCell and PSCell changes may use a common identifier space which means that the conditional reconfiguration for PCell change may have the same identifier as the another conditional reconfiguration for a PSCell change.

### BRIEF DESCRIPTION

Some aspects of the invention are defined by the independent claims.

Some embodiments of the invention are defined in the dependent claims.

The embodiments and features, if any, described in this specification that do not fall under the scope of the independent claims are to be interpreted as examples useful for understanding various embodiments of the invention. Some aspects of the disclosure are defined by the independent claims.

According to an aspect, there is provided an apparatus for a terminal device, comprising means for performing: receiving a first cell change message of a first cell change procedure from a first access node serving the terminal device, the first cell change message comprising an identifier of the first cell change procedure; receiving a second cell change message of a second cell change procedure from a second access node serving the terminal device, the second cell change message comprising an identifier of the second cell change procedure, wherein the identifier of the first cell change procedure is identical to the identifier of the second cell change procedure; using information on the first access node and information on the second access node to distinguish the first cell procedure and the second cell change procedure in the apparatus.

In an embodiment, the means are configured to carry out the first cell change procedure and the second cell change procedure in parallel procedures and to associate the information on the first access node with the first cell change procedure and the information on the second access node with the second cell change procedure.

In an embodiment, the means are configured to: initiate the first cell change procedure in the terminal device in connection with receiving the first cell change message, wherein the initiating comprises flagging the first cell change procedure with a flag indicating that the first cell change message was received as a first access node configuration message, and initiate the second cell change procedure in the terminal device in connection with receiving the second cell change message, wherein the initiating comprises flagging the second cell change procedure with a flag indicating that the second cell change message was received as a second access node configuration message.

In an embodiment, the means are configured to store a first configuration defining parameters for the first cell change procedure and a second configuration defining parameters for the second cell change procedure and, upon receiving a further cell change message, to: update the first configuration, if the further cell change message was received as a first access node configuration message; and update the second configuration, if the further cell change message was received as a second secondary access node configuration message.

In an embodiment, the means are configured to detect that the first cell change procedure and the second cell change procedure have the identical identifiers and, upon so detecting, to transmit to one of the first access node and the second access node a message indicating a conflict of identifiers, and to receive from said one of the first access node and the second access node a new identifier for the respective cell change procedure.

In an embodiment, the means are configured to transmit, in connection with the message, a list of proposed identifiers, wherein the new identifier is one of the proposed identifiers.

In an embodiment, a message type of cell change messages received from the first access node differ from a message type of cell change messages received from the second access node, and wherein the means are configured to distinguish the first cell change procedure from the second cell change procedure by determining, on the basis of a message type of a received message, whether or not the received message belongs to the first cell change procedure or second cell change procedure.

In an embodiment, the cell change messages received from the first access node are messages of a conditional handover procedure or an inter-secondary-node conditional primary cell of secondary cell group change procedure, and wherein the cell change messages received from the second access node are messages of an intra-secondary-node conditional primary cell of secondary cell group change procedure.

In an embodiment, the first cell change procedure is a conditional handover procedure where handover of the terminal device is prepared to multiple target primary cells during the conditional handover procedure, and wherein the means are configured to choose when to trigger a handover and to which one of the multiple target primary cells.

In an embodiment, the first cell change procedure is an inter-secondary-node conditional primary cell of secondary cell group change procedure where a change of the primary cell of secondary cell group is prepared for multiple target primary cells of secondary cell groups, during the first cell change procedure, and wherein the means are configured to choose when to trigger a primary cell of secondary cell group change and to which one of the multiple target primary cells of secondary cell groups.

In an embodiment, the second cell change procedure is an intra-secondary-node conditional primary cell of secondary cell group change procedure where a change of the primary cell of secondary cell group is prepared for multiple target primary cells of secondary cell groups, during the second cell change procedure, and wherein the means are configured to choose when to trigger a primary cell of secondary cell group change and to which one of the multiple target primary cells of secondary cell groups. In an embodiment, the means comprises at least one processor and at least one memory including computer program code, the at least one memory and computer program code configured to, with the at least one processor, cause the performance of the apparatus.

According to an aspect, there is provided a method comprising: receiving, by a terminal device, a first cell change message of a first cell change procedure from a first access node serving the terminal device, the first cell change message comprising an identifier of the first cell change procedure; receiving, by the terminal device, a second cell change message of a second cell change procedure from a second access node serving the terminal device, the second cell change message comprising an identifier of the second cell change procedure, wherein the identifier of the first cell change procedure is identical to the identifier of the second cell change procedure; using, by the terminal device, information on the first access node and information on the second access node to distinguish the first cell procedure and the second cell change procedure in the apparatus.

In an embodiment, the terminal device carries out the first cell change procedure and the second cell change procedure in parallel procedures and associates the information on the first access node with the first cell change procedure and the information on the second access node with the second cell change procedure.

In an embodiment, the method further comprises: initiating the first cell change procedure in the terminal device in connection with receiving the first cell change message, wherein the initiating comprises flagging the first cell change procedure with a flag indicating that the first cell change message was received as a first access node configuration message, and initiating the second cell change procedure in the terminal device in connection with receiving the second cell change message, wherein the initiating comprises flagging the second cell change procedure with a flag indicating that the second cell change message was received as a second access node configuration message.

In an embodiment, the terminal device stores a first configuration defining parameters for the first cell change procedure and a second configuration defining parameters for the second cell change procedure and, upon receiving a further cell change message: updates the first configuration, if the further cell change message was received as a first access node configuration message; and updates the second configuration, if the further cell change message was received as a second secondary access node configuration message.

In an embodiment, the terminal device detects that the first cell change procedure and the second cell change procedure have the identical identifiers and, upon so detecting, transmits to one of the first access node and the second access node a message indicating a conflict of identifiers, and receives from said one of the first access node and the second access node a new identifier for the respective cell change procedure.

In an embodiment, the terminal device transmits, in connection with the message, a list of proposed identifiers, wherein the new identifier is one of the proposed identifiers.

In an embodiment, a message type of cell change messages received from the first access node differ from a message type of cell change messages received from the second access node, and wherein the terminal device distinguishes the first cell change procedure from the second cell change procedure by determining, on the basis of a message type of a received message, whether or not the received message belongs to the first cell change procedure or second cell change procedure.

In an embodiment, the cell change messages received from the first access node are messages of a conditional handover procedure or an inter-secondary-node conditional primary cell of secondary cell group change procedure, and wherein the cell change messages received from the second access node are messages of an intra-secondary-node conditional primary cell of secondary cell group change procedure.

In an embodiment, the first cell change procedure is a conditional handover procedure where handover of the terminal device is prepared to multiple target primary cells during the conditional handover procedure, and wherein the terminal device chooses when to trigger a handover and to which one of the multiple target primary cells.

In an embodiment, the first cell change procedure is an inter-secondary-node conditional primary cell of secondary cell group change procedure where a change of the primary cell of secondary cell group is prepared for multiple target primary cells of secondary cell groups, during the first cell change procedure, and wherein the terminal device chooses when to trigger a primary cell of secondary cell group change and to which one of the multiple target primary cells of secondary cell groups.

In an embodiment, the second cell change procedure is an intra-secondary-node conditional primary cell of secondary cell group change procedure where a change of the primary cell of secondary cell group is prepared for multiple target primary cells of secondary cell groups, during the second cell change procedure, and wherein the terminal device chooses when to trigger a primary cell of secondary cell group change and to which one of the multiple target primary cells of secondary cell groups.

According to an aspect, there is provided a computer program product embodied on a computer-readable medium and comprising a computer program code readable by a computer, wherein the computer program code configures the computer to carry out a computer process in a terminal device, the computer process comprising: receiving a first cell change message of a first cell change procedure from a first access node serving the terminal device, the first cell change message comprising an identifier of the first cell change procedure; receiving a second cell change message of a second cell change procedure from a second access node serving the terminal device, the second cell change message comprising an identifier of the second cell change procedure, wherein the identifier of the first cell change procedure is identical to the identifier of the second cell change procedure; using information on the first access node and information on the second access node to distinguish the first cell procedure and the second cell change procedure in the apparatus.

### LIST OF DRAWINGS

Embodiments are described below, by way of example only, with reference to the accompanying drawings, in which

FIG. 1 illustrates a wireless communication scenario to which some embodiments of the invention may be applied;

FIG. 2 illustrates one handover scenario in connection with multi-connectivity;

FIG. 3 illustrates an embodiment of a process for solving a conflict between identifiers of cell change procedures;

FIG. 4 illustrates a functional block diagram of an apparatus according to an embodiment;

FIG. 5 illustrates a procedure to separating concurrent handover procedures sharing the same identifier in a terminal device;

FIG. 6 illustrates a signalling diagram of an embodiment for reconfiguring a conflicting identifier of a cell change procedure; and

FIG. 7 illustrates a block diagram of a structure of an apparatus according to an embodiment of the invention.

### DESCRIPTION OF EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. A person skilled in the art will realize that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows terminal devices or user devices 100, 101, and 102 configured to be in a wireless connection on one or more communication channels in a cell with an access node (such as (e/g)NodeB) 104 providing the cell. (e/g)NodeB refers to an eNodeB or a gNodeB, as defined in 3GPP specifications. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used not only for signalling purposes but also for routing data from one (e/g)NodeB to another. The (e/g)NodeB is a computing device configured to control the radio resources of communication system it is coupled to. The NodeB may also be referred to as a base station, an access point, an access node, or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and typically fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 105) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 109 in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

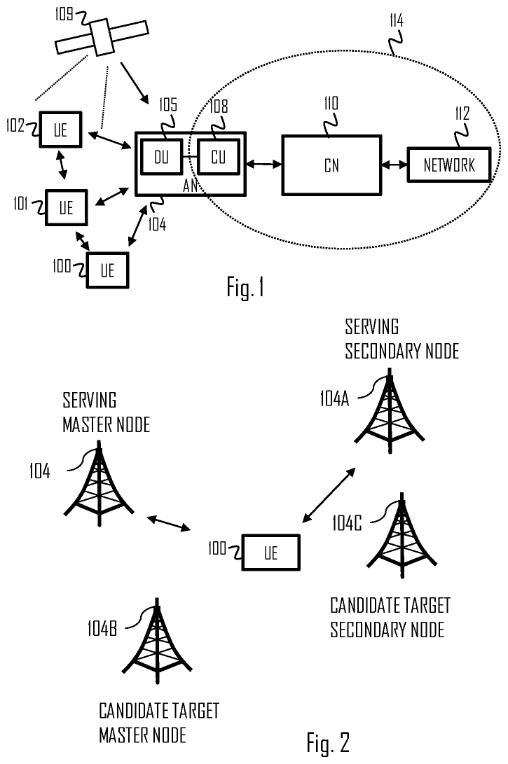

FIG. 2 illustrates a scenario where the terminal device 100 is served concurrently by a master node 104 and by a secondary node 104A. In such a multi-connectivity scenario, the terminal device may be served by a master cell group (MCG) comprising the primary cell of MCG and optionally one or more secondary cells that are controlled by the master node 104; and by a secondary cell group (SCG) comprising of a primary cell of SCG (PSCell) and optionally one or more secondary cells (different from the secondary cells of the MCG) that are controlled by the secondary node 104A. The PSCell may distinguish from the secondary cells of the SCG in that it is configured with physical uplink control channel (PUCCH) resources. The cells of the SCG may have no control plane connection with the core network 110 but they communicate with the serving master node 104 in the control plane.

For mobility and beam tracking purposes, the terminal device may be configured to report signal strength measurements of the neighbour cells to one or both (all) serving nodes 104, 104A. An example of the reported signal strength is reference signal received power (RSRP). Other examples are reference signal received quality (RSRQ) and signal-to-interference ratio (SINR). The reporting can be event-triggered or periodic. Some triggers are described in specifications of 3rd Generation Partnership Project (3GPP). The neighbour cell measurements may be downlink measurements. Handover decisions are conventionally made on the basis of the downlink measurements. In the multi-connectivity scenario of FIG. 2, there may be various cell changes, including such handovers. PCell change may be referred to as handover.

The 5G New Radio implements a conditional cell change concept for the primary cell of MCG (PCell) and the primary cell of SCG (PSCell). Let us call a conditional handover procedure of PCell as conditional handover (CHO) and a conditional change of PSCell as conditional PSCell change (CPC). The CHO involves the conventional downlink handover measurements of one or more non-serving cells performed and reported by the terminal device to the serving PCell (the master access node 104). The downlink handover measurements may include measuring a reception signal strength of a signal received from each detected non-serving cell. On the basis of the reported downlink measurements, the access node 104 may determine to trigger the conditional handover (CHO) preparations. For example, the CHO preparations may be triggered when the received signal strength of a target cell exceeds the signal strength of the serving cell by a predefined offset. The CHO preparations may comprise transmitting a handover request to non-serving cells indicated as potential candidates for the CHO by the reported measurements. The candidate cells are controlled by access node 104B in the example of FIG. 2. The access node 104B may acknowledge the handover request by transmitting a response. The response message may comprise that at least one parameter of the respective access node in the non-serving cell. Upon receiving the parameter(s) from each non-serving cell, the serving access node 104 may transmit to the terminal device 100 one or more control messages that configure the CHO parameters to the terminal device. The serving access node may thus forward the parameters received from the non-serving cell(s) to the terminal device. Upon receiving the parameters of the non-serving cells, the terminal device may start performing functions for triggering a handover to one of the non-serving cells by taking into account one or more conditions of the terminal device for triggering the handover execution. There may be various internal conditions and/or conditions provided by the serving access node 104 that affect when the terminal device 100 chooses to trigger the handover execution, e.g., the radio measurement of target cell becomes better than that of the serving cell or exceeds a threshold. Upon detecting that a condition for triggering a handover to one of the non-serving cells has been satisfied, the terminal device may connect to the non-serving cell (the target access node 104B) for which the condition was fulfilled. As a consequence, the terminal device may transmit a connection request to the target cell via a random access channel (RACH) procedure. Upon receiving the connection request or upon completing the RRC connection reconfiguration, the access node 104B of the target cell becomes a new master access node managing a new primary cell for the terminal device, and it may transmit a handover notification message to the access node 104 to indicate that the handover has been completed. Then, the access node 104 may indicate to the other access node(s) with which the conditional handover was prepared that the handover is over, and the other access node(s) may terminate the handover preparations.

The CPC procedure has been specified for both an intra-secondary-node (intra-SN CPC) scenario and an inter-secondary-node (inter-SN CPC) scenario. In the latter scenario, the CPC may be triggered by the master node 104 or the secondary node 104A serving the terminal device 100 (FIG. 2). Let us now take the CPC procedure triggered by the secondary node as an example because such a scenario may cause the identifier conflict described in background. A first step is that the source secondary node 104A indicates to master node identifiers of target secondary nodes (e.g. access node 104C) that shall be contacted for preparing target PSCells. The source secondary node may suggest a list of PSCells to be prepared by each target secondary node and provide a CPC execution condition for each suggested target PSCell. Then, the master node 104 may send an addition request to each target secondary node indicated by source secondary node. Each target secondary node may decide on the candidate target PSCells to prepare out of the list of PSCells that are suggested by source secondary node. Each target secondary node then sends to master node the CPC configuration for each prepared target PSCell and an identifier of each prepared target PSCell. The master node then sends to the terminal device 100 a conditional configuration containing the CPC configurations of the candidate target PSCell(s) along with the CPC execution conditions. The terminal device may acknowledge the received conditional configuration and the master access node also confirms in turn the completed preparations to the source secondary node. Similarly to the CHO, the terminal evaluates the CPC execution conditions of the prepared target PSCell(s) and, when the CPC execution condition is met for a target PSCell, the terminal device sends a message to the master node indicating the execution of the CPC configuration. The message may include an embedded secondary node RRC Reconfiguration Complete to the target secondary node. The terminal device may complete the CPC procedure by carrying out a random access procedure with the target PSCell for establishing the RRC connection.

The CHO and the CPC procedures are thus independent cell change procedures having different purposes. The purpose of the CHO is to improve the reliability of a PCell while the purpose of the CPC is to reduce access latency and/or improve the reliability of the PSCell.

A conditional cell change procedure may be assigned with an identifier that is used to identify the conditional cell procedure. In the 5G New Radio specifications, such an identifier is called a reconfiguration identifier (condReconfigId-r16). The reconfiguration identifier is generated and sent to the terminal device upon initiating the respective conditional cell procedure (CHO or CPC). The reconfiguration identifier is generated by the master node in case of the CHO or the inter-secondary-node CPC. On the other hand, the reconfiguration identifier is generated by the secondary node in case of the intra-secondary-node CPC transparently to the master access node. As described in Background, because of the co-existence of the different conditional cell change procedures, both the master node and the secondary node providing the terminal device 100 with the multi-connectivity are able to trigger a conditional cell change procedure of the terminal device 100 independently and concurrently. Furthermore, since they use a common identifier pool for the reconfiguration identifier, the conflict in the reconfiguration identifier may occur in the terminal device. The terminal device is configured to store all conditional cell change configurations in a record called varConditionalReconfig, where each cell change configuration is identified with the reconfiguration identifier. The record having this name is used for the above-described configurations of both the conditional handover and the CPC. In case there are two concurrent cell change procedures having the same reconfiguration identifier, the record gets corrupted with mixed information on both cell change procedures, thus causing erroneous behavior of the terminal device.

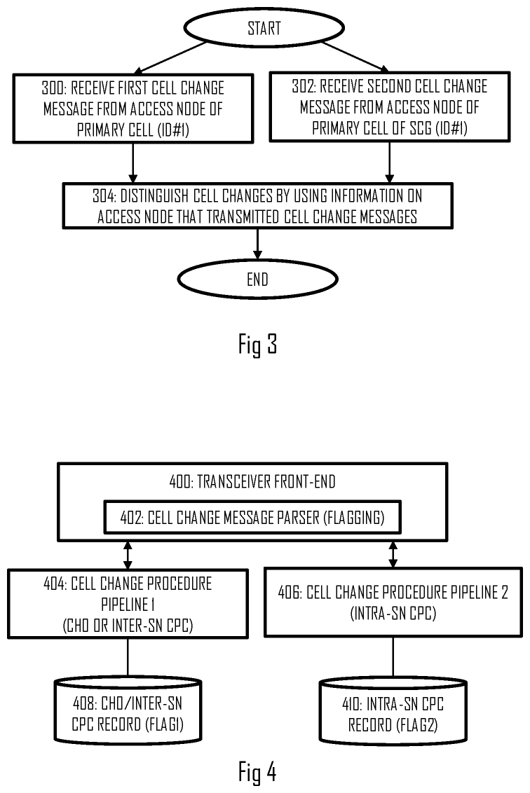

FIG. 3 illustrates an embodiment of a process for managing the conflict of reconfiguration identifiers in an apparatus for the terminal device. Referring to FIG. 3, the process carried out by the apparatus comprises: receiving (block 300) a first cell change message of a first cell change procedure from a first access node serving the terminal device in a primary cell of master cell group, the first cell change message comprising an identifier of the first cell change procedure; receiving (block 302) a second cell change message of a second cell change procedure from a second access node serving the terminal device in primary cell of secondary cell group, the second cell change message comprising an identifier of the second cell change procedure, wherein the identifier of the first cell change procedure is identical to the identifier of the second cell change procedure; and using (block 304) information on the first access node and information on the second access node to distinguish the first cell change procedure and the second cell change procedure in the apparatus.

A technical advantage of the procedure of solving the identifier conflict is correct operation of the terminal device in a case of the identifier conflict, thus improving also overall system performance by reducing unpredictable behavior of the terminal device. Furthermore, the proposed solution eliminates a need for network coordination in managing the reconfiguration identifiers, as each network entity can set the reconfiguration identifier without coordinating with other network node. The proposed solution is also scalable compared to the network coordination because the network coordination would become more complex if more network nodes would be involved in the multi-connectivity.

In an embodiment, the first cell change procedure and the second cell change procedure are carried out as parallel procedures in the terminal device, and the information on the first access node is associated with the first cell change procedure and the information on the second access node is associated with the second cell change procedure in the terminal device in order to distinguish the two cell change procedures.

In an embodiment the first cell change procedure is the CHO procedure where handover of the terminal device is prepared to multiple target primary cells during the conditional handover procedure, and wherein the terminal device chooses when to trigger a handover and to which one of the multiple target primary cells. In another embodiment, the first handover procedure is an inter-secondary-node CPC procedure.

In an embodiment, the second cell change procedure is the CPC procedure where a change of the secondary cell is prepared for multiple target PSCells during the CPC procedure, and wherein the terminal device chooses when to trigger a PSCell change and to which one of the multiple target PSCells. The CPC procedure may be an intra-secondary-node CPC procedure.

As described above, the first and second cell change procedures may be triggered by the different access nodes serving the same terminal device in the multi-connectivity scenario.

FIG. 4 illustrates a functional diagram of the apparatus for the terminal device 100 in the context of separating the concurrent cell change procedures. Referring to FIG. 4, the apparatus may comprise a transceiver front-end 400 comprising transceiver circuitries configured to transmit and receive cell change messages with the access nodes 104 and 104A that are source access nodes for the cell change. The transceiver front-end may include a digital transceiver circuitry and, optionally, radio transceiver circuitries required for radio communications. In case where the apparatus is a chipset, the apparatus may employ external radio transceiver circuitries for the purpose of radio communications. The transceiver front-end 402 may comprise a cell change message parser configured to distinguish the source of a received cell message and to label (flag) the received cell message with a flag indicating the cell change procedure to which the received message belongs. For example, a first flag (flag1) may be associated with the CHO procedure or inter-secondary-node CPC while a second flag (flag2) may be associated with the intra-secondary-node CPC procedure. In other words, upon initiating the first cell change procedure in the terminal device in connection with receiving the first cell change message, the cell change message parser 402 may flag the first cell change procedure with the first flag indicating that first cell change message is received from first access node configuration message. Similarly, upon initiating the second cell change procedure in the terminal device in connection with receiving the second cell change message, the cell change message parser may flag the second cell change procedure with the second flag indicating that the second cell change message is received from second access node configuration message. Correspondingly flagged records 408, 410 may be generated for respective cell change procedures. Upon receiving a message from the first access node, the cell change message parser may output the message to a cell change procedure pipeline 404 managing the cell change with the involvement of first access node (the CHO or inter-secondary-node CPC pipeline), wherein the cell change procedure pipeline 404 manages the record 408. In an embodiment, the cell change message parser may flag the message with the first flag before outputting the cell change message to the pipeline 404. Similarly, upon receiving a message from the second access node, the cell change message parser 402 may output the message to a cell change procedure pipeline 406 managing the cell change with the second access node (the intra-SN CPC pipeline), wherein the cell change procedure pipeline 406 manages the record 410. In an embodiment, the cell change message parser may flag the message with the second flag before outputting the cell change message to the pipeline 406. In this manner, the two cell change procedures are carried out in different ‘pipelines’ and do not get mixed even if they share the same reconfiguration identifier and stored in the same UE variable, e.g. ‘VarCondReconfiguration’ according to 5G NR specifications. The pipeline as a term should be understood such that the two cell change procedures having the same identifier are logically separated in the terminal device, e.g. isolated from one another.

In an embodiment, the first flag is associated with the first access node 104 in various cell change procedures triggered or managed by the first (master) access node. For example, the terminal device may associate the same flag with the CHO and the inter-secondary-access node CPC procedures triggered by the first access node 104. The logic is that the first access node will not assign the same reconfiguration identifier to multiple concurrent cell change procedures and, therefore, the different cell change procedures can be distinguished even under the same flag. Similarly, the second flag may be associated with the second access node in the various (even concurrent) cell change procedures triggered or managed by the second access node.

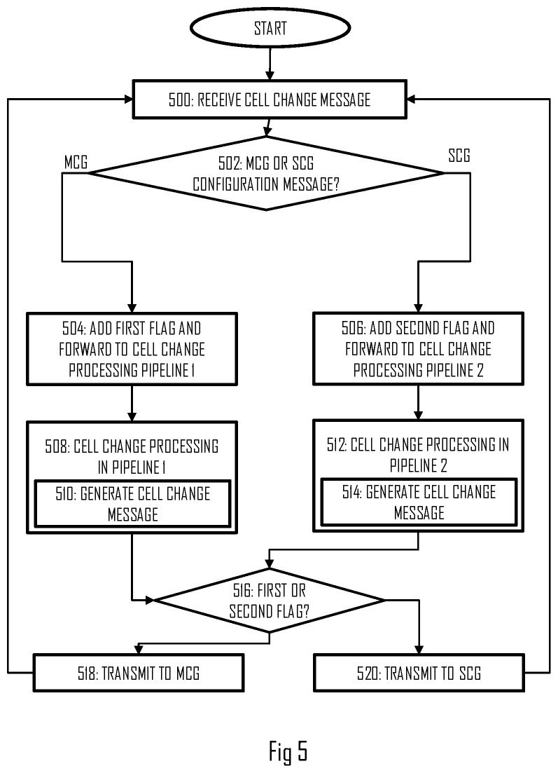

In an embodiment, the terminal device stores a first configuration (e.g. record 408) defining parameters for the first cell change procedure and a second configuration (e.g. record 410) defining parameters for the second cell change procedure and, upon receiving a further cell change message, the terminal device updates the first configuration, if the further cell message was received from the MCG/MN configuration message, and updates the second configuration, if the further cell change message was received from the SCG/SN configuration message. Accordingly, the cell group identified by a cell identifier of a transmitter of the further cell change message may be used as a criterion for separating the concurrent cell change procedures in the terminal device. FIG. 5 illustrates such a procedure that is directly applicable to other embodiments using another criterion for distinguishing the concurrent cell change procedures sharing the same identifier in the terminal device.

Referring to FIG. 5, the terminal device receives a cell change message in block 500 from an access node. In block 502, the terminal device determines information on the transmitting entity of the cell change message, e.g. whether the cell message was received in or as a MCG or an SCG configuration message. Upon determining that the cell change message was received in or as the MCG configuration message, the terminal device may flag the message with a flag associated with the MCG and forward the flagged cell change message to a first cell change processing pipeline (block 504). Upon determining that the cell change message was received in or as the SCG configuration message, the terminal device may flag the message with a flag associated with the SCG and forward the flagged cell change message to a second cell change processing pipeline (block 506). The cell change processing in the respective pipelines in blocks 508 and 512 may follow the state-of-the-art cell change procedures, with the exception that the flag may be carried in the processing to distinguish the processes, e.g. in a case where the pipelines are realized by the same physical processing circuitry. If the cell change message is a first cell message of a cell change procedure, the processing in blocks 508, 512 may comprise generating the respective record for maintaining the configuration of the respective cell change. For example, the flag may be added to the record to distinguish the respective records maintained by the pipelines. The cell change processing in blocks 508, 512 may include generating a cell change message (blocks 510, 514) that may be a response to the cell change message received in block 500. Block 510, 514 may include flagging the generated cell change message and outputting the flagged cell change message to block 516 where a target access node is determined for the cell change message. Block 516 comprises evaluating the flag. Upon determining that the flag of the cell change message is associated to the MCG configuration message, the cell message is transmitted to the access node of the MCG in block 518. Upon determining that the flag of the cell change message is associated to the SCG, the cell change message is transmitted to the access node of the SCG in block 520. Thereafter, the procedure may end or return to block 500 for receiving a further handover message. In case the received message does not induce transmission of a message to the access node in block 508 or 512, the process may end or return to block 500. Blocks 500, 502, and 516 to 520 may be performed by the transceiver front-end 400 comprising the cell change message parser 402, as described above.

The flag may be used to distinguish the procedures between blocks 502, 516. After block 516, the respective messages transmitted in blocks 518, 520 may associated with the respective access node by other means, thus distinguishing the different cell change messages by the access node. Such other means may include a message type of the respective access node, uplink transmission resources scheduled by the respective access node, etc.

In an embodiment a message type of the received cell change message is used by the terminal device to distinguish the cell change procedure to which the cell change message belongs. A message type of cell messages received from the first access node differ from a message type of cell change messages received from the second access node. For example, the message type of the CHO messages or inter-secondary-node CPC may differ from the message type of the CPC messages. As another embodiment, the master node may transmit master node reconfiguration messages (for CHO or inter-secondary-node CPC) while the secondary node may transmit secondary node reconfiguration messages (for intra-secondary-node CPC) that are distinguishable from the master node reconfiguration messages. It should be noted that in some cases, the secondary node may transmit reconfiguration messages to the terminal device via the master node and, in such cases, the message type is suitable for distinguishing the reconfiguration messages of the secondary node from the reconfiguration messages of the master node. Accordingly, the cell change message parser may distinguish the first cell change procedure from the second cell change procedure by determining, on the basis of a message type of a received cell change message, whether or not the received cell change message belongs to the first cell change procedure or second cell change procedure.

In an embodiment, the terminal device may run a procedure for detecting the conflicting identifiers of the cell change procedures. Upon detecting multiple concurrent cell change procedures, the terminal device may run a check for comparing (reconfiguration) identifiers of the concurrent cell change procedures. If no conflict is detected, e.g. the concurrent cell change procedures have different identifiers, the terminal device may use the identifiers to distinguish the cell change procedures. For example, the cell change procedures are then inherently allocated to maintain different records. Upon detecting the conflict, the terminal device may take a further identifier into use to logically separate the concurrent procedures, e.g. the flag or another local identifier internal to the terminal device. From a perspective, terminal device may be understood to perform an identifier translation on the basis of the identifier and the information on the access nodes with which the concurrent cell change procedures are being executed. The pieces of information on the access nodes may be unique to each access node, thus enabling the terminal device to distinguish the cell change procedures.

In an embodiment, the flag is added to the (reconfiguration) identifier of the respective cell change procedures in the terminal device. From a logical sense, two embodiments can be distinguished. In one embodiment, the cell change procedures share the same record (variable) with two sub-records: one flagged to the first cell change procedure, and another flagged to the second cell change procedure. In another embodiment, the cell change procedures use separate records (variables), as described above. The (reconfiguration) identifier of the respective records may be arranged to incorporate the flag. Accordingly, the terminal device maintains distinguishable records for each cell change procedure even in a case of identifier conflict.

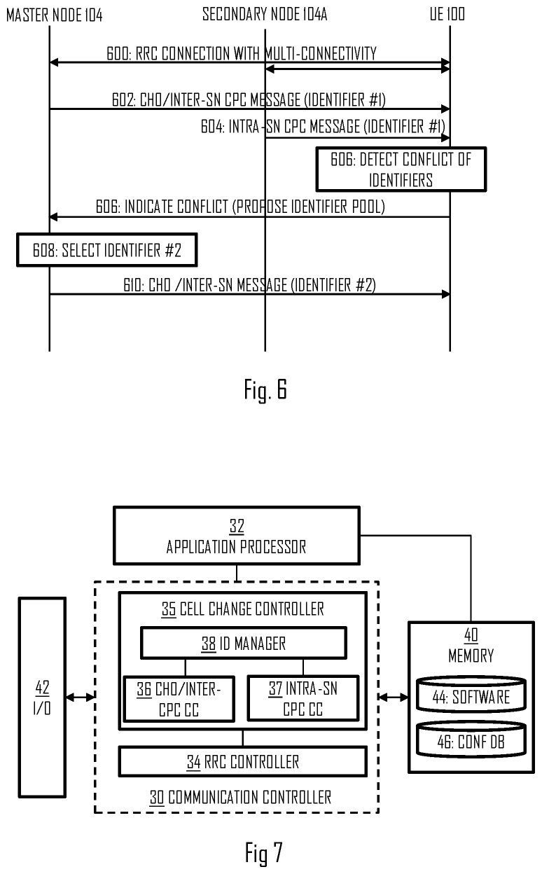

In an embodiment, upon detecting that the first cell change procedure and the second cell change procedure have the identical identifiers, the terminal device transmits to one of the first access node and the second access node a message indicating the conflict of identifiers and receives from said one of the first access node and the second access node a new identifier for the respective cell change procedure. FIG. 6 illustrates an embodiment of such a procedure. Referring to FIG. 6, the terminal device 100 establishes a multi-connectivity radio resource control (RRC) connection with the master node 104 and the secondary node 104A in step 600 according to the state-of-the-art procedures. In step 602, the master node 104 transmits the first cell change message (e.g. a CHO message or inter-secondary-node CPC) defining a reconfiguration identifier for the first cell change procedure (identifier #1). While the first cell change procedure is on-going, the secondary node 104A transmits the second cell change message defining a reconfiguration identifier for the second cell procedure (step 604). This reconfiguration identifier is the same as the reconfiguration identifier of the first cell change procedure (identifier #1). In block 606, the terminal device detects the conflict of identifiers between the two cell change procedures and, in response to the detection, generates a message to the master node. The message comprises at least one information element indicating the conflict of reconfiguration identifiers to the master node. In an embodiment, the message further comprises at least one information element indicating one or more reconfiguration identifiers proposed by the terminal device to replace the conflicting identifier in the first cell change procedure. The at least one information element indicating one or more reconfiguration identifiers proposed by the terminal device may refer to a list of reconfiguration identifiers that would not result in such a conflict. In block 608 upon receiving the message in step 606, the master node selects a new reconfiguration identifier (identifier #2) for the first cell change procedure to solve the conflict. In case the terminal device has proposed the one or more reconfiguration identifiers in step 606, the master node may select one of the proposed reconfiguration identifiers. Otherwise, the master node may select a reconfiguration identifier from a pool of reconfiguration identifiers maintained by the master node. In step 610, the master node transmits a cell change message to the terminal device, the cell change message being a reconfiguration message that reconfigures the reconfiguration identifier for the first cell change procedure. Upon receiving the message in step 610, the terminal device reconfigures the reconfiguration identifier of the first cell change procedure. The terminal device may have suspended the second cell change procedure until the identifier conflict has been solved in order not to interfere the first cell change procedure that was already on-going when the second cell change procedure was initiated in step 604. Equivalently, steps 606 to 610 may be carried out between the terminal device and the secondary access node 104A.

FIG. 7 illustrates an apparatus comprising a processing circuitry, such as at least one processor, and at least one memory 40 including a computer program code (software) 44, wherein the at least one memory and the computer program code (software) are configured, with the at least one processor, to cause the apparatus to carry out the process of FIG. 3 or any one of its embodiments described above for the terminal device. The apparatus may be for the terminal device. The apparatus may be a circuitry or an electronic device realizing some embodiments of the invention in the terminal device. The apparatus carrying out the above-described functionalities may thus be comprised in such a device, e.g. the apparatus may comprise a circuitry such as a chip, a chipset, a processor, a micro controller, or a combination of such circuitries for the terminal device. The processing circuitry may realize a communication controller 30 controlling communications with the access nodes 104, 104A to 104C of the cellular network infrastructure in the above-described manner. The communication controller may comprise a RRC controller 34 configured to establish and manage RRC connections and transfer of data over the RRC connections via the above-described multi-connectivity scenario.

The communication controller 30 may further comprise a cell change controller 35 configured to manage cell changes of the terminal device. The cell change controller 35 may comprise a CHO or inter-secondary-node CPC controller 36 configured perform the above-described procedures during the CHO or inter-secondary-node CPC, for example. As another example, the cell change controller 35 may comprise an intra-secondary-node CPC controller 37 configured perform the above-described procedures during the intra-secondary-node CPC. As a consequence, both cell change controllers may use the received parameters of the target non-serving cells and the principles of the conditional cell changes to select a target cell, primary cell of MCG or SCG, and to trigger the cell change when the cell change condition is met in the above-described manner.

The cell change controller 35 may further comprise an identifier manager configured to monitor identifiers of the cell change procedures executed or triggered in the terminal device in order to detect the above-described identifier conflict and, upon detecting the conflict, use any one of the above-described embodiments to solve the conflict before the conflict escalates into the concurrent cell change procedures becoming mixed.

Referring to FIG. 7, the memory 40 may be implemented using any suitable data storage technology, such as semiconductor-based memory devices, flash memory, magnetic memory devices and systems, optical memory devices and systems, fixed memory and removable memory. The memory 40 may comprise a configuration database 46 for storing configuration parameters, e.g. the various cell change parameters received in connection with the cell change preparation such as the conditions for triggering the cell change.

The apparatus may further comprise a communication interface 42 comprising hardware and/or software for providing the apparatus with radio communication capability with one or more access nodes, as described above. The communication interface 42. The communication interface 42 may comprise hardware and software needed for realizing the radio communications over the radio interface, e.g. according to specifications of an LTE or 5G radio interface.

The apparatus may further comprise an application processor 32 executing one or more computer program applications that generate a need to transmit and/or receive data through the communication controller 30. The application processor may form an application layer of the apparatus. The application processor may execute computer programs forming the primary function of the apparatus. For example, if the apparatus is a sensor device, the application processor may execute one or more signal processing applications processing measurement data acquired from one or more sensor heads. If the apparatus is a computer system of a vehicle, the application processor may execute a media application and/or an autonomous driving and navigation application. The application processor may generate data to be transmitted in the wireless network.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention. The processes or methods described in connection with FIGS. 3A to 6 or any of the embodiments thereof may also be carried out in the form of one or more computer processes defined by one or more computer programs. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Embodiments described herein are applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1-24. (canceled)

25. An apparatus for a terminal device, comprising at least one processor, and at least one memory storing instructions that, when executed by the at least one processor, cause the apparatus at least to:
receive a first cell change message of a first cell change procedure from a first access node serving the terminal device, the first cell change message comprising an identifier of the first cell change procedure, wherein the first access node is a Master node (MN) and wherein the first cell change refers to a conditional handover (CHO);
receive a second cell change message of a second cell change procedure from a second access node serving the terminal device, wherein the second access node is a Secondary node (SN), and wherein the second cell change refers to a conditional PSCell change (CPC), and wherein PSCell refers to a primary cell of a secondary cell group (SCG), and the second cell change message comprising an identifier of the second cell change procedure, wherein the identifier of the first cell change procedure is identical to the identifier of the second cell change procedure; use information on the first access node and information on the second access node to distinguish the first cell procedure and the second cell change procedure in the apparatus, wherein the CHO and the CPC procedures are independent and concurrent cell change procedures, and wherein the apparatus is configured to store independent varConditionalReconfig records for the CHO and the CPC procedure, respectively.

26. The apparatus of claim 25, wherein the apparatus is further configured to carry out the first cell change procedure and the second cell change procedure in parallel procedures and to associate the information on the first access node with the first cell change procedure and the information on the second access node with the second cell change procedure.

27. The apparatus of claim 25, wherein the apparatus is further configured to:
initiate the first cell change procedure in the terminal device in connection with receiving the first cell change message, wherein the initiating comprises flagging the first cell change procedure with a flag indicating that the first cell change message was received as a first access node configuration message, and
initiate the second cell change procedure in the terminal device in connection with receiving the second cell change message, wherein the initiating comprises flagging the second cell change procedure with a flag indicating that the second cell change message was received as a second access node configuration message.

28. The apparatus of claim 25, wherein the apparatus is further configured to store a first configuration defining parameters for the first cell change procedure and a second configuration defining parameters for the second cell change procedure and, upon receiving a further cell change message, to:
update the first configuration, if the further cell change message was received as a first access node configuration message; and
update the second configuration, if the further cell change message was received as a second secondary access node configuration message.

29. The apparatus of claim 25, wherein the apparatus is further configured to detect that the first cell change procedure and the second cell change procedure have the identical identifiers and, upon so detecting, to transmit to one of the first access node and the second access node a message indicating a conflict of identifiers, and to receive from said one of the first access node and the second access node a new identifier for the respective cell change procedure.

30. The apparatus of claim 29, wherein the apparatus is further configured to transmit, in connection with the message, a list of proposed identifiers, wherein the new identifier is one of the proposed identifiers.

31. The apparatus of claim 25, wherein a message type of cell change messages received from the first access node differ from a message type of cell change messages received from the second access node, and wherein the means are configured to distinguish the first cell change procedure from the second cell change procedure by determining, on the basis of a message type of a received message, whether or not the received message belongs to the first cell change procedure or second cell change procedure.

32. The apparatus of claim 31, wherein the cell change messages received from the first access node are messages of a conditional handover procedure or an inter-secondary-node conditional primary cell of secondary cell group change procedure, and wherein the cell change messages received from the second access node are messages of an intra-secondary-node conditional primary cell of secondary cell group change procedure.

33. The apparatus of claim 25, wherein the first cell change procedure is a conditional handover procedure where handover of the terminal device is prepared to multiple target primary cells during the conditional handover procedure, and wherein the means are configured to choose when to trigger a handover and to which one of the multiple target primary cells.

34. The apparatus of claim 25, wherein the first cell change procedure is an inter-secondary-node conditional primary cell of secondary cell group change procedure where a change of the primary cell of secondary cell group is prepared for multiple target primary cells of secondary cell groups, during the first cell change procedure, and wherein the means are configured to choose when to trigger a primary cell of secondary cell group change and to which one of the multiple target primary cells of secondary cell groups.

35. The apparatus of claim 25, wherein the second cell change procedure is an intra-secondary-node conditional primary cell of secondary cell group change procedure where a change of the primary cell of secondary cell group is prepared for multiple target primary cells of secondary cell groups, during the second cell change procedure, and wherein the means are configured to choose when to trigger a primary cell of secondary cell group change and to which one of the multiple target primary cells of secondary cell groups.

36. The apparatus of claim 25, wherein the apparatus comprises at least one processor and at least one memory including computer program code, the at least one memory and computer program code configured to, with the at least one processor, cause the performance of the apparatus.

37. A method comprising:
receiving, by a terminal device, a first cell change message of a first cell change procedure from a first access node serving the terminal device, the first cell change message comprising an identifier of the first cell change procedure; wherein the first access node is a Master node (MN) and wherein the first cell change refers to a conditional handover (CHO);
receiving, by the terminal device, a second cell change message of a second cell change procedure from a second access node serving the terminal device, the second cell change message comprising an identifier of the second cell change procedure, wherein the identifier of the first cell change procedure is identical to the identifier of the second cell change procedure; and wherein the second access node is a Secondary node (SN), and wherein the second cell change refers to a conditional PSCell change (CPC), and wherein PSCell refers to a primary cell of a secondary cell group (SCG), and
using, by the terminal device, information on the first access node and information on the second access node to distinguish the first cell procedure and the second cell change procedure in the apparatus; wherein the CHO and the CPC procedures are independent and concurrent cell change procedures, and wherein the method further comprises: storing independent varConditionalReconfig records for the CHO and the CPC procedure, respectively.

38. The method of claim 37, wherein the terminal device carries out the first cell change procedure and the second cell change procedure in parallel procedures and associates the information on the first access node with the first cell change procedure and the information on the second access node with the second cell change procedure.

39. The method of claim 37, further comprising:
initiating the first cell change procedure in the terminal device in connection with receiving the first cell change message, wherein the initiating comprises flagging the first cell change procedure with a flag indicating that the first cell change message was received as a first access node configuration message, and
initiating the second cell change procedure in the terminal device in connection with receiving the second cell change message, wherein the initiating comprises flagging the second cell change procedure with a flag indicating that the second cell change message was received as a second access node configuration message.

40. The method of claim 37, wherein the terminal device stores a first configuration defining parameters for the first cell change procedure and a second configuration defining parameters for the second cell change procedure and, upon receiving a further cell change message:
updates the first configuration, if the further cell change message was received as a first access node configuration message; and
updates the second configuration, if the further cell change message was received as a second secondary access node configuration message.

41. The method of claim 37, wherein the terminal device detects that the first cell change procedure and the second cell change procedure have the identical identifiers and, upon so detecting, transmits to one of the first access node and the second access node a message indicating a conflict of identifiers, and receives from said one of the first access node and the second access node a new identifier for the respective cell change procedure.

42. The method of claim 41, wherein the terminal device transmits, in connection with the message, a list of proposed identifiers, wherein the new identifier is one of the proposed identifiers.

43. The method of claim 37, wherein a message type of cell change messages received from the first access node differ from a message type of cell change messages received from the second access node, and wherein the terminal device distinguishes the first cell change procedure from the second cell change procedure by determining, on the basis of a message type of a received message, whether or not the received message belongs to the first cell change procedure or second cell change procedure.

44. The method of claim 43, wherein the cell change messages received from the first access node are messages of a conditional handover procedure or an inter-secondary-node conditional primary cell of secondary cell group change procedure, and wherein the cell change messages received from the second access node are messages of an intra-secondary-node conditional primary cell of secondary cell group change procedure.

45. The method of claim 37, wherein the first cell change procedure is a conditional handover procedure where handover of the terminal device is prepared to multiple target primary cells during the conditional handover procedure, and wherein the terminal device chooses when to trigger a handover and to which one of the multiple target primary cells.

46. The method of claim 37, wherein the first cell change procedure is an inter-secondary-node conditional primary cell of secondary cell group change procedure where a change of the primary cell of secondary cell group is prepared for multiple target primary cells of secondary cell groups, during the first cell change procedure, and wherein the terminal device chooses when to trigger a primary cell of secondary cell group change and to which one of the multiple target primary cells of secondary cell groups.

47. The method of claim 37, wherein the second cell change procedure is an intra-secondary-node conditional primary cell of secondary cell group change procedure where a change of the primary cell of secondary cell group is prepared for multiple target primary cells of secondary cell groups, during the second cell change procedure, and wherein the terminal device chooses when to trigger a primary cell of secondary cell group change and to which one of the multiple target primary cells of secondary cell groups.

48. A computer program product embodied on a computer-readable medium and comprising a computer program code readable by a computer, wherein the computer program code configures the computer to carry out the method of claim 37.
